(19) United States
(12) Patent Application Publication
(10) Pub. No.: US 2025/0124340 A1
(43) Pub. Date: Apr. 17, 2025

(54) METHOD, ELECTRONIC DEVICE, AND COMPUTER PROGRAM PRODUCT FOR CONSTRUCTING TRAINING DATA

(71) Applicant: Dell Products L.P., Round Rock, TX (US)

(72) Inventors: Jiacheng Ni, Shanghai (CN); Zijia Wang, Weifang (CN); Zhisong Liu, Shenzhen (CN); Zhen Jia, Shanghai (CN)

(21) Appl. No.: 18/503,403

(22) Filed: Nov. 7, 2023

(30) Foreign Application Priority Data
Oct. 13, 2023 (CN) 202311333218.4

(51) Int. Cl. G06N 20/00

(52) U.S. Cl. CPC G06N 20/00

(57) ABSTRACT

Embodiments of the present disclosure relate to a method, an electronic device, and a computer program product for constructing training data. The method includes determining multiple clusters by clustering prompts in a training dataset; and determining, based on multiple cohesion levels of the multiple clusters, multiple sampling probabilities corresponding to the multiple clusters, where the cohesion levels indicate intra-cluster distances in the clusters. The method further includes determining, according to the multiple sampling probabilities, a target cluster for sampling. The method further includes constructing target training data by sampling target prompts from the target cluster. According to embodiments of the present disclosure, when fine-tuning a language model, prompts can be screened according to a clustering result of the prompts, so as to make the determined prompts more valuable for annotation, thereby ensuring output results of the language model obtained by training to be comprehensive and diverse.

### RELATED APPLICATION

The present application claims priority to Chinese Patent Application No. 202311333218.4, filed Oct. 13, 2023, and entitled “Method, Electronic Device, and Computer Program Product for Constructing Training Data,” which is incorporated by reference herein in its entirety.

### FIELD

The present disclosure generally relates to the field of machine learning, and more specifically, to a method, an electronic device, and a computer program product for constructing training data.

### BACKGROUND

With the development of artificial intelligence learning paradigms, language models have become an increasingly important topic in the field of artificial intelligence. The language models learn rich language and world knowledge through pretraining on massive text data, enabling such models to achieve astonishing results in various natural language processing (NLP) tasks.

In order to make the output of the language models more in line with human preferences, the language models can be fine-tuned by using reinforcement learning with human feedback, so that the language models can generate more accurate, logically coherent, and readable output results. In the process of fine-tuning the language models, it is desirable to use more efficient prompts to guide the language models and improve the training efficiency of the language models.

### SUMMARY

Embodiments of the present disclosure provide a method, an electronic device, and a computer program product for constructing training data.

According to a first aspect of the present disclosure, a method for constructing training data is provided. The method includes determining multiple clusters by clustering prompts in a training dataset; and determining, based on multiple cohesion levels of the multiple clusters, multiple sampling probabilities corresponding to the multiple clusters, where the cohesion levels indicate intra-cluster distances in the clusters. The method further includes determining, according to the multiple sampling probabilities, a target cluster for sampling. The method further includes constructing target training data by sampling target prompts from the target cluster. Therefore, multiple screening can be performed on the prompts in the training dataset, making the prompts screened out more valuable for annotation. Thus, it can reduce the annotation workload of an annotator, and save annotation costs and processing resources. In addition, sampling the target prompts from each target cluster can avoid the randomness of prompt sampling. In this way, it can ensure that while saving annotation resources, the language model output results are further improved to be more diverse and personalized, and also more in line with human preferences.

According to a second aspect of the present disclosure, an electronic device is provided. The electronic device includes at least one processor and a memory coupled to the at least one processor and having instructions stored thereon, wherein the instructions, when executed by the at least one processor, cause the electronic device to perform actions comprising determining multiple clusters by clustering prompts in a training dataset; and determining, based on multiple cohesion levels of the multiple clusters, multiple sampling probabilities corresponding to the multiple clusters, where the cohesion levels indicate intra-cluster distances in the clusters. The actions further include determining, according to the multiple sampling probabilities, a target cluster for sampling. The actions further include constructing target training data by sampling target prompts from the target cluster.

According to a third aspect of the present disclosure, a computer program product is provided. The computer program product is tangibly stored on a non-transitory computer-readable medium and includes machine-executable instructions, wherein the machine-executable instructions, when executed by a machine, cause the machine to perform steps of the method in the first aspect of the present disclosure.

This Summary is provided to introduce the selection of concepts in a simplified form, which will be further described in the Detailed Description below. The Summary is neither intended to identify key features or principal features of the claimed subject matter, nor intended to limit the scope of the claimed subject matter.

### BRIEF DESCRIPTION OF THE DRAWINGS

The above and other features, advantages, and aspects of embodiments of the present disclosure will become more apparent in conjunction with the accompanying drawings and with reference to the following Detailed Description. In the accompanying drawings, identical or similar reference numerals represent identical or similar elements, in which:

FIG. 1 shows a schematic diagram of a workflow of training a language model by reinforcement learning with human feedback in an illustrative embodiment;

FIG. 2 shows a schematic diagram of an example environment in which multiple embodiments of the present disclosure can be implemented;

FIG. 3 shows a schematic diagram of a process for training a reward model according to multiple embodiments of the present disclosure;

FIG. 4 shows a flow chart of a method for further screening target prompts according to multiple embodiments of the present disclosure;

FIG. 5 shows a flow chart of a method for constructing training data according to multiple embodiments of the present disclosure;

FIG. 6 shows a schematic diagram of a workflow of determining candidate output results by using a beam search algorithm according to multiple embodiments of the present disclosure; and

FIG. 7 shows a block diagram of an electronic device according to some embodiments of the present disclosure.

In all the accompanying drawings, identical or similar reference numerals indicate identical or similar elements.

### DETAILED DESCRIPTION

It can be understood that the data involved in this technical solution (including but not limited to the data itself, the acquisition or use of data) should comply with the requirements of corresponding laws and relevant regulations.

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be understood as “at least one embodiment.” The terms “first,” “second,” and the like may refer to different or identical objects, unless explicitly illustrated. Other explicit and implicit definitions may also be included below.

Language models are an important technology in the field of natural language processing and text generation, with broad application prospects and development space. A language model is a model that utilizes a deep learning technology to learn the laws and knowledge of language based on a large amount of text data, thereby generating natural and fluent text. A large language model has strong expression and generalization abilities, and can be applied to various natural language processing tasks, such as machine translation, text summarization, dialogue systems, question and answering systems, etc.

With the continuous development of algorithms, hardware, data, and application scenarios, users' performance requirements for a language model are also constantly increasing. In order to generate different outputs for a language model based on different users, applications, and application scenarios, fine-tuning can be performed on a language model. Fine-tuning refers to the use of labeled data in specific application scenarios to further adjust and train a language model to make it more suitable for a specific application scenario.

Reinforcement learning with human feedback (RLHF) is a popular technology in recent years to improve the performance of a language model. RLHF is a technology that combines reinforcement learning with human feedback, where human preferences are used as reward signals to guide a language model to generate high-quality language output. RLHF can utilize diverse feedback providers to help the model learn to generate texts that better represent different perspectives, making them more universal and effective in various contexts. However, when training the language model, annotators annotate a large amount of unlabeled training data (e.g., prompts), which consumes a lot of human resources. Moreover, due to the randomness of prompt sampling, the language model may not be able to access a more comprehensive language pattern, resulting in the output of the language model not meeting expected outputs of users.

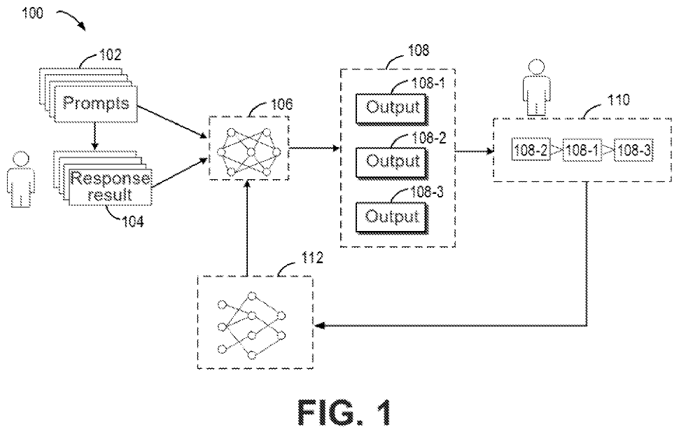

FIG. 1 shows a schematic diagram of a workflow 100 of training a language model by RLHF in an illustrative embodiment. As shown in FIG. 1, prompts 102 and a response result 104 (e.g., annotation data) compiled by an annotator for the prompts can be input to a language model 106 (e.g., GPT-3.5) so as to pretrain the language model 106. Then, the language model 106 can generate multiple outputs 108 corresponding to the prompts, for example, an output 108-1, an output 108-2, and an output 108-3. The annotator evaluates the multiple generated outputs 108 and sorts the multiple outputs 108 from an optimal output to a worst output, so as to obtain a sorting result 110. Further, a reward model 112 predicts scores of the multiple outputs of the language model. By means of the outputs 108 from the training of the language model 106 and sorting scores, the reward model 112 can create a mathematic representation of human preferences. Finally, by means of reinforcement learning, the reward model 112 can be used as a reward function to fine-tune the language model 106, so as to enable the language model 106 to generate an output result with a higher score in the reward model 112.

Still further, in embodiments of the present disclosure, before inputting the prompts and response result to the language model for fine-tuning, the prompts can be screened, so as to enable a user to selectively annotate the prompts screened out. In embodiments of the present disclosure, clustering can be performed on prompts in a training dataset to determine multiple clusters. Then, a cohesion level corresponding to each cluster can be determined according to an intra-cluster distance of each cluster. The cohesion level is used to represent a similarity degree between prompts included in the cluster. Further, multiple sampling probabilities corresponding to the clusters are determined based on the cohesion levels corresponding to the clusters. Then, a target cluster for sampling is determined according to the multiple sampling probabilities. Finally, target prompts are sampled from the target cluster to construct training data.

Hence, screening can be performed on the prompts in the training dataset, making the prompts screened out more valuable for annotation. Thus, it can reduce the annotation workload of an annotator, and save annotation costs and processing resources. In addition, sampling the target prompts from each target cluster can avoid the randomness of prompt sampling. In this way, it can ensure that while saving annotation resources, the language model output results are further improved to be more diverse and personalized, and also more in line with human preferences.

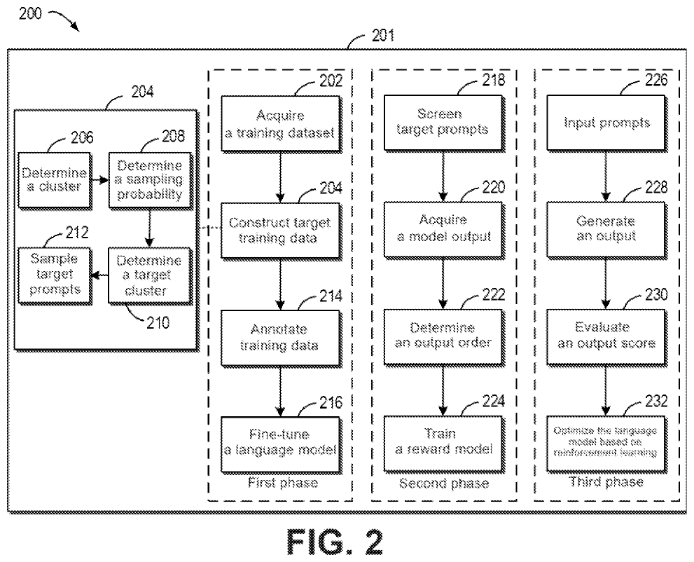

FIG. 2 shows a schematic diagram of an example environment 200 in which multiple embodiments of the present disclosure can be implemented. As shown in FIG. 2, the example environment includes a computing device 201. In some implementations, the computing device 201 may be implemented as a variety of user terminals or service terminals with computing capabilities. The service terminals may be servers provided by various service providers, large-scale computing devices, and the like. For example, the user terminals may be any type of mobile, fixed, or portable terminals, including a mobile phone, a site, a unit, a device, a multimedia computer, a multimedia tablet, an Internet node, a communicator, a desktop computer, a laptop computer, a notebook computer, a netbook computer, a tablet computer, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination thereof, including accessories and peripherals of such devices, or any combination thereof. It can also be expected that the computing device 201 may support a user-specific interface (such as “wearable” circuit) of any type.

As shown in FIG. 2, a computing device 201 includes a workflow of training a language model by using a training dataset, where the workflow includes three phases. The first phase is a supervised fine-tune (SFT) phase, which can pretrain the language model through self-supervision by using collected text data, and then fine-tune the language model by using manually annotated data. At block 202, a training dataset can be acquired, for example, the training dataset can be acquired directly from an open platform, or the training dataset can be constructed by collecting open text data from the Internet. The training dataset contains multiple prompts, for example, “how to use xx function,” “tell a fairy tale to a 6-year-old child,” etc.

At block 204, after acquiring the training dataset, prompts in the training dataset can be sampled to construct target training data for fine-tuning the language model. The prompts are texts input to the language model and can be used to prompt or guide a large model to provide expected output results. Types of the prompts are questions and answers, abstracts, and translations. At block 206, multiple clusters are determined by clustering the prompts in the training dataset. For example, a clustering algorithm can be used to cluster the prompts and automatically classify the prompts into different groups to form multiple clusters. Each cluster can represent a subject matter of a type of prompts.

At block 208, due to difference cohesion levels of different clusters, for example, the tightness of the prompts in the clusters and the centroid varies. In order to make training data for training the language model more sufficient and comprehensive and avoid randomness of prompt sampling, sampling probabilities corresponding to the clusters are determined according to the cohesion levels of the clusters. The lower the coherence level, the lower the similarity between the various prompts contained in the cluster, and the cluster theme does not fully cover various prompts within the cluster. Furthermore, the sampling probabilities of the clusters can be determined according to the cohesion levels corresponding to the clusters, where the sampling probabilities refer to the probabilities for constructing the training data by sampling prompts in the clusters. For example, sampling probabilities of the clusters with low cohesion levels can be improved.

At block 210, a target cluster for sampling can be determined according to the sampling probability. For example, several clusters with high sampling probabilities can be determined as target clusters. At block 212, after determining the target cluster, training data can be constructed by sampling the target prompts from the target cluster. In this way, a user does not need to annotate all prompts in a training dataset and can instead annotate only prompts obtained from sampling, thus reducing the work of manual annotation and saving a large amount of annotation costs. In addition, since the target prompts are sampled from the target cluster, it makes the data annotation have higher quality and more valuable. At block 214, after sampling the target prompts, an annotator annotates the target prompts, for example, compile output results or response results corresponding to the target prompts. At block 216, the target training data is constructed by combining the target prompts and corresponding outputs. The target training data is used to fine-tune the language model.

With continued reference to FIG. 2, the second phase is a training reward model phase. During the training reward model phase, evaluation results for evaluating multiple output results of the language model by a user can be acquired, and scores are used to train the reward model, so as to enable the reward model to judge output results of the language model in the future. In the reinforcement learning, the reward function can evaluate (e.g., score) the current output so as to enable a policy model to generate higher quality outputs. Correspondingly, during a process of training the language model by using the reinforcement learning, the language model is regarded as a policy model. The reward model can be another fine-tuned language model or a language model trained from scratch according to preference data.

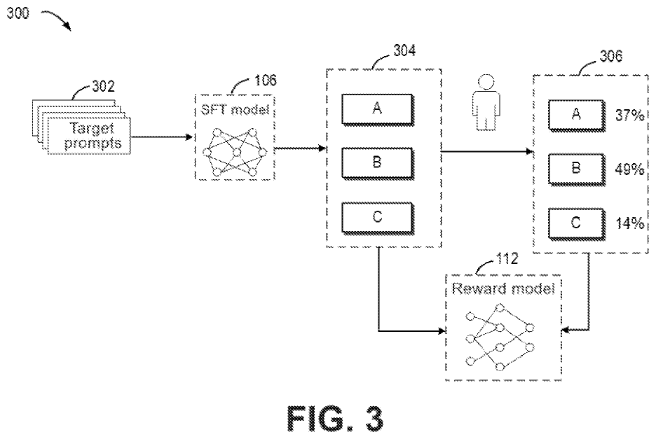

At block 218, the target prompts may be further screened according to predicted output results corresponding to the target prompts. At block 220, the target prompts screened out are input to the language model, and output results corresponding to the target prompts are output after being processed by the language model. At block 222, the annotator can evaluate the output results of the target prompts screened out and sort the output results according to preferences and application needs. At block 224, after receiving the sorting sequence of the user, the sorting sequence can be used to train the reward model. FIG. 3 shows a schematic diagram of a process 300 for training a reward model according to multiple embodiments of the present disclosure.

As shown in FIG. 3, sampled target prompts 302 can be output to language model 106, also referred to in this embodiment as an SFT model, and processed by the language model 106 to obtain multiple outputs 304, such as A, B, and C. An annotator can evaluate the multiple outputs 304 to determine a sorting sequence 306 among the multiple outputs 304, for example, a preference level by the annotator for A is 37%, a preference level for B is 49%, and a preference level for C is 14%. Finally, the sorting sequence 306 and the multiple outputs 304 can be input to a reward model 112 to train the reward model 112. In this way, it can make the scoring results of the reward model obtained by training consistent with human values, thereby making the output results of the fine-tuned language model more in line with user preferences.

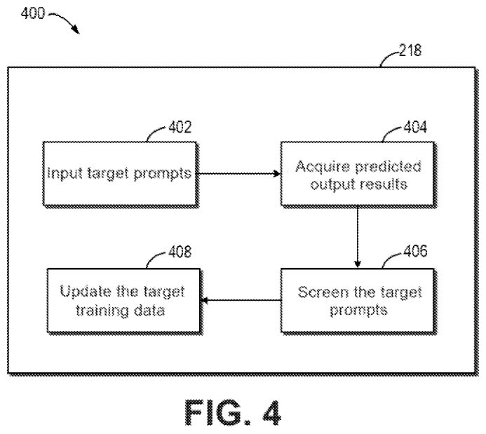

In some embodiments, to further save manual annotation resources and enable the annotator to focus his/her annotation efforts on more “valuable” target prompts, the target prompts can be further screened. If a target prompt is not accurate (e.g., the intention contained in the prompt is unclear), the answer generated by the language model may be very broad, and “the response certainty” of the generated answer is not high. In order to make the language model output more accurate, logically coherent, and readable outputs, the annotator can be requested to further annotate the target prompts, such as evaluating the output results corresponding to the target prompts to determine an answer that best meets a user's needs. Correspondingly, multiple target prompts can be input to the language model, and predicted output results corresponding to the multiple target prompts are determined. If there is a large quantity of predicted output results or the results have a significant difference, the target prompts are further annotated. FIG. 4 shows a flow chart of a method 400 for further screening target prompts according to multiple embodiments of the present disclosure.

As shown in FIG. 4, at block 402, multiple target prompts in training data can be sequentially input to a language model. At block 404, the language model can output predicted output results corresponding to the target prompts. The quantity of the predicted output results may include multiple predicted output results. At block 406, the target prompts can be further screened according to the predicted output results. For example, the target prompts with a large quantity of predicted output results or a significant difference between the predicted output results are selected. At block 408, the target training data can be updated after screening the target prompts, and an annotator is requested to further annotate the target prompts screened out. For example, the output results corresponding to the target prompts screened out can be sorted to determine a sorting result.

Referring again to FIG. 2, the third phase is a phase of fine-tuning a language model by using a reinforcement learning algorithm. For example, a policy gradient reinforcement learning (Policy Gradient RL) algorithm and proximal policy optimization (PPO) can be used to fine-tune some or all of the parameters of the language model. At block 226, prompts can be sampled from the updated target training data, and the sampled prompts are input to the language model. At block 228, an output generated by the language model for the prompts can be acquired. At block 230, the reward model is used to calculate an evaluated score of the output. At block 232, the evaluated score and the reinforcement learning algorithm are used to fine-tune or otherwise optimize the language model.

A solution for constructing training data and fine-tuning a language model by using the training data according to embodiments of the present disclosure is described above with reference to FIG. 1 to FIG. 4. As compared with a traditional method, in embodiments of the present disclosure, multiple screenings can be performed on prompts within the training dataset when constructing the training data, making the prompts screened out more valuable for annotation, thereby reducing the annotation workload of an annotator and saving annotation resources. In some embodiments, due to the use of prompts such as “incomplete instruction information” and “unclear output result” in the annotation data during the process of fine-tuning the language model, the language model obtained by fine-tuning is more comprehensive in terms of language modes, and the output answers are more in line with user preferences.

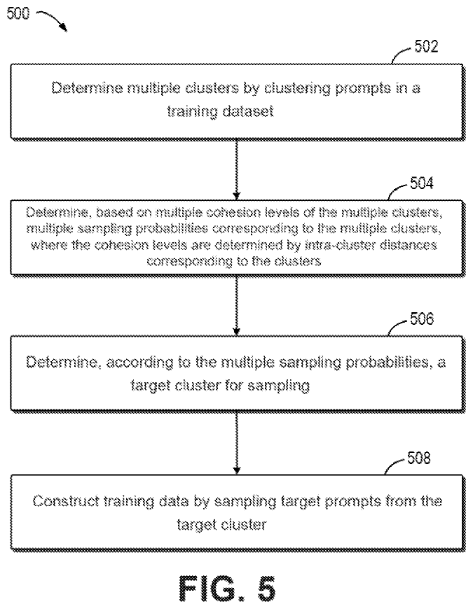

FIG. 5 shows a flow chart of a method 500 for constructing training data according to multiple embodiments of the present disclosure. The method 500 can be implemented by the computing device 201 as shown in FIG. 2. It should be understood that the method 500 may also include additional actions not shown and/or omit actions shown, and the scope of the present disclosure is not limited in this regard.

As shown in FIG. 5, at block 502, a computing device can acquire a training dataset and cluster prompts in the training dataset to determine multiple clusters. The training dataset can be generated by Application Programming Interface (API) prompts or collected from Q&A in a public NLP dataset. The training prompt contains multiple prompts. The prompt refers to an input text used to trigger or guide a large model to generate content. The input text can be in various languages, such as English, Chinese, French, etc. For example, the prompts can be “the recipe of frying tomatoes and eggs,” “introducing physical scientist Newton,” “recommending weight loss recipes,” and so on.

Further, after acquiring the training dataset, prompts in the training dataset are clustered to determine the multiple clusters or multiple piles. That is, clustering is used to partition the training dataset into different clusters or piles. For example, there are multiple types of clustering methods, which can be mainly divided into partition-based clustering methods, density-based clustering methods, and hierarchical clustering methods. The partition-based clustering methods may include the K-means clustering algorithm and the K-means++ clustering algorithm. When clustering, similar prompts can be classified together to form a cluster. In this way, the subject matters of the prompts contained in a cluster are roughly the same.

At block 504, a cohesion level corresponding to the cluster can be determined according to an intra-cluster distance of the cluster, and a sampling probability of the cluster can be determined by using the cohesion level. The intra-cluster distance is used to represent distances between the prompts contained in the cluster and the centroid of the cluster. The smaller the intra-cluster distance, the closer the prompts within the cluster, and the higher the cohesion level corresponding to the cluster. Correspondingly, a topic coverage of the cluster is relatively high, that is, the prompts in the cluster have a relatively high similarity level (e.g., the type similarity level is relatively high). Further, after the cohesion level corresponding to the cluster is determined, the sampling probability of the cluster can be determined according to the cohesion level. The sampling probability is used to represent the probability or possibility of sampling prompts from the cluster.

In some embodiments, to ensure that the prompts annotated by annotators have annotation value, the sampling probability corresponding to clusters with low cohesion levels can be increased, while the sampling probability corresponding to clusters with high cohesion levels can be reduced. As stated above, the similarity of prompts contained in the clusters with low cohesion levels is not high, so it is necessary to sample multiple prompts from the cluster so as to ensure comprehensiveness and representativeness of the sampling. Correspondingly, the sampling probability is negatively correlated with the coherence level and positively correlated with the intra-cluster distance. The negative correlation refers to a negative correlation coefficient between the sampling probability and the coherence level. A high coherence level results in a low sampling probability. The positive correlation refers to a negative correlation coefficient between the sampling probability and the intra-cluster distance. If the intra-cluster distance is short, the sampling probability is low.

In some embodiments, distances between the prompts in the cluster and the centroid are respectively calculated, and a statistical value of the distances is used as an intra-cluster distance of the cluster. The statistical value can be the sum, average, median, sum of squares, etc. of the distances. In some embodiments, the distance between a prompt and the centroid can be the Euclidean distance, Manhattan distance, cosine distance, etc. The mean of all prompts in the cluster is usually referred to as the “centroid” of the cluster. In other embodiments, the cohesion levels can also be determined based on weighted values of the distances between the prompts in the cluster and the distances between the prompts and the centroid.

At block 506, a target cluster for sampling can be determined according to sampling probabilities corresponding to the clusters. For example, the sampling probabilities corresponding to each cluster can be sorted, and the clusters ranked with the top 50% sampling probability are used as the target clusters, thereby avoiding the randomness of prompt sampling and further ensuring that the language model obtained by training contacts more comprehensive prompts and language patterns.

At block 508, target training data is constructed by sampling multiple target prompts from a target cluster. For example, multiple target prompts can be sampled at once from the multiple target clusters, or the sampling steps can be repeated to sample multiple target prompts.

In this way, prompts in a training dataset can be sampled when constructing training data, making the sampled prompts more valuable for annotation, thereby reducing the annotation workload of an annotator and saving annotation resources. In addition, target prompts are sampled from a cluster with a high sampling probability, thereby avoiding the randomness of prompt sampling and making the output of the language model obtained through fine-tuning more comprehensive and diverse.

In some embodiments, a sampling probability distribution can be determined by statistically analyzing the sampling probabilities of multiple target clusters. Then, a sampling method for sampling the target prompts can be determined according to the sampling probability distribution. For example, the sampling probability distribution conforms to a normal distribution, the target prompts can be sampled according to a sampling method corresponding to the normal distribution. In some embodiments, to ensure the uniformity of sampling, the target prompts can be sampled from each target cluster using a uniform sampling method. Among them, the uniform sampling method can include roulette, function transformation methods, etc.

In some embodiments, the quantity of target prompts sampled from the target cluster can be determined according to a probability density function corresponding to the sampling probability distribution. For example, when the sampling probability at the target cluster A is 70%, the sampling probability of the target cluster B is 30%, and a total quantity of sampling target prompts is 100, it can be set that 70 target prompts are sampled from the target cluster A, and 30 target prompts are sampled from the target cluster B. Therefore, the predetermined sampling quantity corresponding to the target cluster A is 70, and the predetermined sampling quantity corresponding to the target cluster B is 30. It can be understood that after determining a predetermined sampling quantity, the target prompts can be sampled from the target cluster once, or multiple target prompts can be sequentially sampled from the target cluster. The probability of each prompt being sampled in the target cluster is the same.

In some embodiments, before clustering the prompts in the training dataset, to improve the clustering efficiency and stability, the language model can be used to encode the prompts into embeddings in vector forms. The embeddings of the prompts include semantic information of the prompts. The embeddings of the prompts can be vectors of the same dimension, on which addition, dot product, and other operations can be performed. Therefore, the similarity between the embeddings corresponding to two prompts can be determined by calculating the cosine distance, the Euclidean distance, and so on. Therefore, the similarity between the embeddings corresponding to the prompts can be used to cluster the prompts.

In some embodiments, after sampling the prompts in the training dataset, the annotator can be requested to compile a response result for the target prompts. Therefore, after receiving the response result compiled by the annotator, the response result can be combined with the prompt to construct target training data, thereby saving annotation resources. The target training data is input to the language model for training the language model (e.g., the first phase shown in FIG. 2). Based on this method, the trained language model can provide an output that meets user preferences when facing multiple prompts, thereby improving user experience.

In some embodiments, there may be similar prompts in a training dataset, such as “Beijing's delicious hot pot” and “which hot pot in Beijing is delicious” are two equivalent prompts. Therefore, before constructing the target training data, the training dataset can be deduplicated to save processing resources. The training dataset can be deduplicated using a hash algorithm. When deduplicating, each word in the training dataset can generate a hash value by means of a hash function, and the hash value can be in the form of a fixed binary representation for a given word. Therefore, the similarity between two prompts can be calculated according to hash values corresponding to the two prompts, and one of the two prompts with a high similarity can be removed. The benefit of doing so is that it can provide a relatively “clean” training dataset for subsequent training data construction tasks, which can save computational resources and to some extent ensure the accuracy of subsequently determining the target cluster.

In some embodiments, to further save manual annotation resources and enable the annotator to focus his/her annotation efforts on more “valuable” target prompts, the target prompts can be further screened. Generally, if a prompt is not accurate (e.g., the intention contained in the prompt is unclear), answers generated by the language model may be very broad, i.e., “the response certainty” corresponding to the prompt is not high. In order to make the language model output more accurate, logically coherent, and readable, the target prompts can be further screened, and the annotator can be requested to evaluate the output results corresponding to the target prompts screened out to determine the answer that best meets the user's needs. Therefore, in some embodiments, multiple target prompts can be input to the language model, and predicted output results corresponding to the multiple target prompts are determined. If there is a large quantity of the predicted output results or the results have a significant difference, the target prompts are further annotated. In this way, the target prompts can be further screened, thereby further saving annotation resources.

In some embodiments, the target prompts can be screened according to the quantity and similarity level of the predicted output results. For example, if the quantity of the predicted output results corresponding to a certain prompt is relatively large, or the similarity level between the predicted output results is not high, the target prompt can be reannotated. Reannotation is to input the target prompt into the language model to obtain multiple candidate output results, and request a user to evaluate the multiple candidate output results, for example, asking if the user thinks that the candidate output results are reasonable, accurate, meaningful, and so on.

After determining the sorting sequence, the sorting sequence can be used to sort the reward model (such as the reward model in FIG. 2) so as to fine-tune the language model. In this way, the output results corresponding to the target prompts screened out are sorted according to human preferences so as to enable the language model obtained by training to output answers in line with human preferences in the future.

In some embodiments, the essential task of the language model can be to predict what the next word will be. That is, a word sequence is given, and the probability distribution of the next word is calculated. Correspondingly, the output of the language model can be a segment of a text sequence. The text sequence can include multiple texts such as first text, second text, and third text. The form of the text can be in the form of words. For example, if the text sequence is “I like cats,” the first text is “I,” the second text is “like,” and the third text is “cats.”

Generally, in a process of obtaining an output of a decoder by the language model, the candidate text with the highest probability is selected at each time step as the output for the current time step until the output is completed. This may cause the output text sequence to not be sufficiently smooth. Although the output at each time step indeed has the highest probability, the overall probability is not necessarily the highest. Therefore, in some embodiments, the language model can use a beam search algorithm to determine multiple candidate output results corresponding to the target prompts. The beam search algorithm preserves more candidate texts when determining the output at each time step. The quantity of candidate texts can be set by users according to actual application needs.

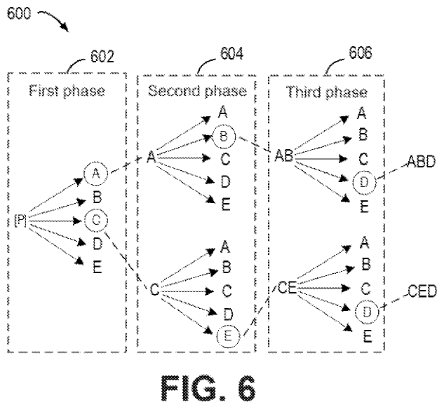

FIG. 6 shows a schematic diagram of a workflow 600 of determining candidate output results by using a beam search algorithm according to multiple embodiments of the present disclosure. As shown in FIG. 6, the beam search includes three phases, corresponding to three time steps (at each time step, a candidate text composing a candidate output result is determined). At the first phase 602, two first candidate texts can be retained, such as “A” and “C.” At the second phase 604, the two first candidate texts of the first phase 602 can be used as inputs to predict outputs of the second phase 604. The second phase 604 can also retain two second candidate texts, such as “B” and “E.” Similarly, the input of the third phase 606 is the two second candidate texts of the second phase 604. Finally, the two candidate output results obtained using the beam search algorithm are ABD and CED. In this way, the candidate output results corresponding to the target prompts can be more natural and smoother.

As stated above, the essence of the language model is to predict a probability distribution of the next word, where the next word can refer to a word, a phrase, or a text in the predicted output result. Therefore, the information entropy corresponding to the probability distribution of the next word can be used to determine the “response certainty” corresponding to the target prompts screened out. That is, if the information entropy corresponding to the probability distribution of the next word is large, then the response certainty of the target prompts is low. On the other hand, if the response certainty corresponding to the target prompts is low, then the quantity of output results corresponding to the target prompts is large, or there is a significant difference between the output results. Therefore, the target prompts with low response certainty can be extracted, the annotator determines the sorting sequence of the output results corresponding to the target prompts, and the sorting results are used to train the language model. The information entropy corresponding to the probability distribution of the next word can be determined based on the text information in the predicted output result.

In this way, the target prompts can be further screened according to the response certainty corresponding to the target prompts, making the target prompts without a clear output result to be further annotated. Thus, the language model obtained by training can output answers meeting user preferences, and the overall performance of the language model can be further improved.

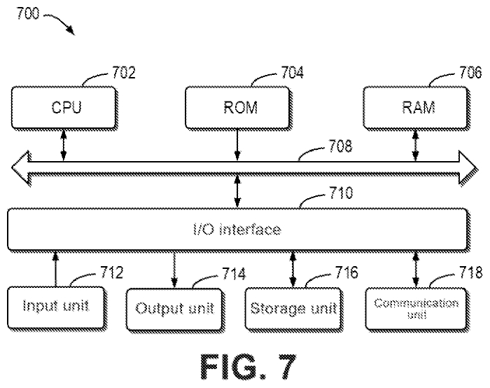

FIG. 7 shows a block diagram of a device 700 according to some embodiments of the present disclosure. The device 700 is an example of an electronic device, and may be a device or apparatus as described in embodiments of the present disclosure. As shown in FIG. 7, the device 700 includes a central processing unit (CPU) 702, and additionally or alternatively may include a graphics processing unit (GPU), although the latter is not explicitly shown in the figure. The CPU 702 and/or the GPU may perform various appropriate actions and processing according to computer program instructions stored in a read-only memory (ROM) 704 or computer program instructions loaded from a storage unit 716 to a random access memory (RAM) 706. In the RAM 706, various programs and data required for the operation of the device 700 may also be stored. The CPU 702 and/or the GPU, the ROM 704, and the RAM 706 are connected to each other through a bus 708. An Input/Output (I/O) interface 710 is also connected to the bus 708. Although not shown in FIG. 7, the device 700 may also include a co-processor.

A plurality of components in the device 700 are connected to the I/O interface 710, including: an input unit 712, such as a keyboard and a mouse; an output unit 714, such as various types of displays and speakers; a storage unit 716, such as a magnetic disk and an optical disc; and a communication unit 718, such as a network card, a modem, and a wireless communication transceiver. The communication unit 718 allows the device 700 to exchange information/data with other devices via a computer network, such as the Internet, and/or various telecommunication networks.

The various methods or processes described above may be executed by the CPU 702 and/or the GPU. For example, in some embodiments, the methods may be implemented as a computer software program that is tangibly included in a machine-readable medium, such as the storage unit 716. In some embodiments, part or all of the computer program may be loaded and/or installed onto the device 700 via the ROM 704 and/or the communication unit 718. When the computer program is loaded into the RAM 706 and executed by the CPU 702 and/or the GPU, one or more steps or actions of the methods or processes described above may be performed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (e.g., connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, other programmable data processing apparatuses, or other devices, so that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, and the module, program segment, or part of an instruction includes one or more executable instructions for implementing specified logical functions. In some alternative implementations, functions marked in the blocks may also occur in an order different from that marked in the accompanying drawings. For example, two successive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented using a special-purpose hardware-based system that executes specified functions or actions, or using a combination of special-purpose hardware and computer instructions.

Various embodiments of the present disclosure have been described above. The foregoing description is illustrative rather than exhaustive, and is not limited to the embodiments disclosed. Numerous modifications and alterations are apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the various embodiments disclosed herein.

Although the present disclosure has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method for constructing training data, comprising:
determining multiple clusters by clustering prompts in a training dataset;
determining, based on multiple cohesion levels of the multiple clusters, multiple sampling probabilities corresponding to the multiple clusters, wherein the cohesion levels indicate intra-cluster distances in the clusters;
determining, according to the multiple sampling probabilities, a target cluster for sampling; and
constructing target training data by sampling target prompts from the target cluster.

2. The method according to claim 1, further comprising:
for each of the clusters, determining a distance between each prompt in the cluster and a centroid of the cluster; and
determining an intra-cluster distance of the cluster according to the distance.

3. The method according to claim 1, wherein the sampling probabilities are negatively correlated with the cohesion levels, and are positively correlated with the intra-cluster distances.

4. The method according to claim 1, wherein sampling the target prompts from the target cluster comprises:
determining a sampling probability distribution according to a sampling probability corresponding to the target cluster; and
sampling the target prompts from the target cluster based on the sampling probability distribution.

5. The method according to claim 4, wherein sampling the target prompts from the target cluster based on the sampling probability distribution comprises:
determining, based on the sampling probability distribution, a predetermined sampling quantity corresponding to the target cluster; and
sampling the predetermined sampling quantity of target prompts from the target cluster.

6. The method according to claim 4, wherein sampling the target prompts from the target cluster based on the sampling probability distribution comprises:
sampling, based on the sampling probability distribution, the target prompts from each target cluster by means of uniform sampling.

7. The method according to claim 1, wherein clustering prompts in the training dataset comprises:
determining embeddings corresponding to the prompts in the training dataset; and
clustering the prompts based on a similarity of the embeddings.

8. The method according to claim 1, further comprising:
receiving a response result determined by a user for the target prompts; and
training a language model based on the response result and the target prompts.

9. The method according to claim 1, before clustering the prompts in the training dataset, further comprising:
determining text hash values corresponding to the prompts in the training dataset; and
deduplicating the training dataset based on the text hash values.

10. The method according to claim 1, further comprising:
inputting the target prompts in the target training data to a language model, wherein a predicted output result corresponding to the target prompts is output after being processed by the language model; and
updating the target training data by screening the target prompts according to the predicted output result.

11. The method according to claim 10, further comprising:
determining, based on the language model, multiple candidate output results corresponding to the target prompts screened out;
receiving a sorting sequence of the multiple candidate output results by a user; and
in response to the sorting, training the language model by using the updated target training data.

12. The method according to claim 11, wherein the candidate output result is a text sequence, the text sequence comprises a first text and a second text, and determining the multiple candidate output results corresponding to the target prompts screened out comprises:
determining a predetermined candidate quantity of first texts by using the language model;
respectively determining the predetermined candidate quantity of second texts corresponding to respective first texts, wherein the second text is located after the first text; and
determining the multiple candidate output results based on multiple corresponding first texts and second texts.

13. The method according to claim 10, wherein screening the target prompts according to the predicted output result comprises:
determining information entropy corresponding to text information in the predicted output result;
determining a response certainty corresponding to the target prompts according to the information entropy; and
screening the target prompts based on the response certainty.

14. An electronic device, comprising:
at least one processor; and
a memory coupled to the at least one processor and having instructions stored thereon, wherein the instructions, when executed by the at least one processor, cause the electronic device to perform actions comprising:
determining multiple clusters by clustering prompts in a training dataset;
determining, based on multiple cohesion levels of the multiple clusters, multiple sampling probabilities corresponding to the multiple clusters, wherein the cohesion levels indicate intra-cluster distances in the clusters;
determining, according to the multiple sampling probabilities, a target cluster for sampling; and
constructing target training data by sampling target prompts from the target cluster.

15. The electronic device according to claim 14, further comprising:
for each of the clusters, determining a distance between each prompt in the cluster and a centroid of the cluster; and
determining an intra-cluster distance of the cluster according to the distance.

16. The electronic device according to claim 14, wherein the sampling probabilities are negatively correlated with the cohesion levels, and are positively correlated with the intra-cluster distances.

17. The electronic device according to claim 14, wherein sampling the target prompts from the target cluster comprises:
determining a sampling probability distribution according to a sampling probability corresponding to the target cluster; and
sampling the target prompts from the target cluster based on the sampling probability distribution.

18. The electronic device according to claim 17, wherein sampling the target prompts from the target cluster based on the sampling probability distribution comprises:
determining, based on the sampling probability distribution, a predetermined sampling quantity corresponding to the target cluster; and
sampling the predetermined sampling quantity of target prompts from the target cluster.

19. The electronic device according to claim 17, wherein sampling the target prompts from the target cluster based on the sampling probability distribution comprises:
sampling, based on the sampling probability distribution, the target prompts from the target cluster by means of uniform sampling.

20. A computer program product, the computer program product being tangibly stored on a non-transitory computer-readable medium and comprising machine-executable instructions, wherein the machine-executable instructions, when executed by a machine, cause the machine to perform actions comprising:
determining multiple clusters by clustering prompts in a training dataset;
determining, based on multiple cohesion levels of the multiple clusters, multiple sampling probabilities corresponding to the multiple clusters, wherein the cohesion levels indicate intra-cluster distances in the clusters;
determining, according to the multiple sampling probabilities, a target cluster for sampling; and
constructing target training data by sampling target prompts from the target cluster.
